(19) United States
(12) Patent Application Publication
(10) Pub. No.: US 2015/0208676 A1
(43) Pub. Date: Jul. 30, 2015

(54) METHOD FOR PREPARING A NATURAL CASING WITH A UNIFORM CALIBER, NATURAL CASING OBTAINED BY SAID METHOD AND FILLED PRODUCT COMPRISING SAID NATURAL CASING

(71) Applicant: Jose Oriol COMAS MARTINEZ DE TEJADA, Barcelona (ES)

(72) Inventor: José Oriol Comas Martinez De Tejada, Barcelona (ES)

(21) Appl. No.: 14/414,582

(22) PCT Filed: Oct. 26, 2012
(86) PCT No.: PCT/IB2012/002150

§ 371 Date: Jan. 13, 2015

(30) Foreign Application Priority Data
Jul. 26, 2012 (ES) P 201200767

(51) Int. Cl. A22C 13/00; A23L 1/317

(52) U.S. Cl. CPC A22C 13/0026; A23L 1/3172; A23L 1/3175; A23V 2002/00

(57) ABSTRACT

The present invention relates to a method for preparing natural casing with a uniform caliber. Said method is based on subjecting a natural casing to an acid treatment followed by an alkaline treatment and then drying at a mild temperature on a flexible and inflatable support with the desired caliber. It also relates to the natural casing which can be obtained by means of said method, to the use thereof for preparing filled products, and to the filled product comprising it as skin.

### FIELD OF THE ART

The present invention is encompassed in the field of skins for filled products and sausages and relates to a process for preparing a modified natural casing having a substantially uniform caliber and an improved appearance.

### STATE OF THE PRIOR ART

Within the framework of the food industry, there are a good number of meat derivatives of the type known as filled products requiring a sheath or wrapping for their preparation which provides them with their shape while at the same time participates in their preservation and even provides flavor. Said filled products can be of various types: cooked filled products, dry filled products or cured filled products or fresh filled products such as sausages.

The skins conventionally used for preparing filled products were the intestines of the animals themselves called natural casing. To that end the small and large intestines of bovine, ovine, caprine, porcine and equine species are mainly used.

The use of natural casing for preparing filled products has significant advantages such as an excellent elasticity, strength, permeability and cling, for example, it also does not have undesired flavors, improves the flavor and appearance of the end product and is edible.

Due to the origin of the natural casing which is removed from the animals after sacrificing them in the slaughterhouse, it is necessary to keep to strict cleaning, hygiene and preservation protocols after removal. The natural casings are usually distributed preserved in salt.

The use of artificial casing for preparing filled products has also become popular in recent years. Artificial casing can be prepared from different materials, collagen, cellulose and plastic being the most common.

Despite that natural casing is generally more popular due to its aforementioned qualities, what is certain is that it also has some drawbacks mainly due to the fact that it is a natural product. Natural casing usually has an irregular shape and various calibers. In contrast, artificial casing can be prepared with exact and specific calibers for each use, which represents a clear advantage especially for preparing filled products industrially.

Therefore, an existing challenge in preparing natural casing is to provide a treatment which allows modifying and making the intestine removed from its natural source uniform for obtaining a natural casing with a uniform caliber and which further allows preparing casing of any length as a result of joining casings with identical caliber.

Some solutions have been described in the state of the art to approach this problem.

Thus, German patent DE970006, for example, describes a method for obtaining a natural casing with a uniform caliber starting from a casing with a higher caliber. Said method comprises treating the natural casing with an acid solution and then drying it on a support with the desired caliber while the casing is stretched by the ends. A casing with a caliber less than the initial caliber is thus obtained.

Likewise, German patent DE3912435 also describes a method for obtaining natural casing with a uniform caliber. To that end the previously desalted natural casing is treated with an aqueous solution of lactic acid which can optionally contain a plasticizer such as glycerin or sorbitol, for example. The casing is subsequently dried moving it forward through a tube having a narrower end through which the casing is introduced, and from which it will move to an expendable section with the desired caliber where the casing is dried by means of air at a temperature of less than 50° C.

U.S. Pat. No. 5,007,878 also describes a method for treating the natural casing having an irregular shape for the purpose of obtaining a casing with a regular caliber. Said method consists of placing the intestine around a support with the desired caliber and subjecting it to a treatment with microwaves.

German patent application DE-A-3216340 also relates to a method for preparing a natural casing with a uniform caliber. Said method consists of introducing an edible artificial casing with a fixed desired caliber into the intestine such that once the filler is introduced, the outer natural casing expands and its size is fixed in the final filled product according to the size of the inner artificial casing. Both natural and artificial casings remain closely joined in the end product.

On the other hand, British patent GB 1492974 describes a method for preserving intestines consisting of treatment with an aqueous acid solution or with a basic solution. After said treatment, the casing is dried preferably stretched around a tube and subjecting it to a temperature between 30-100° C. for a time which can be between several minutes or several hours.

Chinese patent CN-C-100593972 relates to a method for drying natural casing performed on a support made of a flexible material which is inflated with air.

Despite the different proposals described in the state of the art, there is still a need to provide a method for treating natural casing which allows obtaining a casing with all the advantages of a natural casing such elasticity, strength, permeability and cling, for example, but with some of the advantages of an artificial casing particularly in terms of a greater shape and caliber uniformity which allows facilitating the filled product preparation process, and also in terms of having a clearer appearance without the irregularities and imperfections present in non-treated natural casing such as veins and filaments.

### OBJECT OF THE INVENTION

The object of the present invention is a method for preparing a natural casing with a uniform caliber.

Another aspect of the invention is the modified natural casing obtainable according to said method.

Another aspect of the present invention is the use of said modified natural casing for preparing filled products.

Another aspect of the present invention is a filled product comprising said natural casing.

### DESCRIPTION OF THE DRAWINGS

FIG. 1 shows two photographs (A and B) where how the casings once subjected to the dual acid and base treatment according to the present invention, are temporarily arranged in a stainless steel tube before drying can be seen.

FIG. 2 shows two photographs where how the casing is introduced into the inflatable support for drying (A) and how it is removed from same once dried (B) can be seen.

FIG. 3 shows two photographs of the modified natural casing shirred on a tube (A) or folded (B), ready for subsequent distribution.

FIG. 4 (A) shows a casing obtained according to the method of the present invention. FIG. 4 (B) shows a natural casing which has not been subjected to the method of the invention in which various marks and irregularities thereof can be observed.

### DETAILED DESCRIPTION OF THE INVENTION

The present invention relates to a method for preparing a natural casing with a substantially uniform caliber comprising the following steps:

a) treating a natural casing with an aqueous acid solution;

b) treating the casing obtained in step a) with an aqueous alkaline solution; and

c) drying the casing obtained in step b) on a cylindrical support made of a flexible and inflatable material.

The authors of the present invention have developed a method for treating the natural casing which surprisingly allows modifying the original caliber of the casing and obtaining a natural casing with a substantially uniform caliber and which further has significantly improved characteristics in terms of appearance due to its clarity and to the absence of imperfections and irregularities.

In the context of the invention, the term “caliber” means the inner diameter of the casing.

In the context of the invention, the expression “substantially uniform caliber” is interpreted in the sense that the tolerance of the caliber, i.e., the variability of the caliber throughout the casing is equal to or less than 2 mm, preferably less than 2 mm, more preferably less than 1 mm, and yet more preferably less than 0.5 mm.

In the context of the invention, the expression “flexible material” refers to a material which can be folded or twisted and which can be deformed or shaped readily. In this description non-rigid material is used as a synonym and as the opposite to a rigid material.

### Natural Casing

The raw material used in the method of the invention is a natural casing.

The expression “natural casing” refers to the small or large intestine of animals belonging to ovine, bovine, porcine, caprine or equine livestock.

Generally, the natural casing used in the method of the invention has already been subjected previously to all the common cleaning, emptying and scraping processes once removed from the animal after sacrificing them, and it is normally available in salt or in a brine solution for preservation.

The casing used in the method of the present invention is preferably salted, i.e., coated with salt for preservation, such that a first preliminary step before starting the method of the invention consists of eliminating the excess salt by means of washing it with plenty of water.

A natural casing having a caliber preferably comprised between 16 mm and 55 mm and more preferably between 18 mm and 45 mm is used as the starting product.

### Acid Treatment

The first step of the method of the invention, step a), consists of a treatment with an aqueous acid solution.

Said aqueous acid solution has a pH preferably comprised between 4.5 and 6.5 and more preferably comprised between 5 and 6.

To prepare said solution, a food grade acid such as for example, acetic, ascorbic, citric, hydrochloric, glutaric, propanoic or tartaric, among others, or the mixtures thereof, is dissolved in water until obtaining a solution with the required pH.

In a preferred embodiment of the present invention, the acid solution of step a) is an aqueous solution of an acid selected from the group consisting of acetic acid, ascorbic acid, citric acid, hydrochloric acid, glutaric acid, propanoic acid, tartaric acid, and the mixtures thereof; the acid is preferably acetic acid.

Said acid treatment is performed for a period preferably comprised between 4 and 24 hours and more preferably between 8 and 12 hours.

The treatment with the acid solution is usually performed at room temperature.

To carry out the acid treatment the casings are submerged in the aqueous acid solution, stirring the combination gently at first so that they are well impregnated in the solution.

Between 2.5 liters and 4 liters of acid solution are usually used for each kilogram of casing, more preferably approximately 3 liters of acid solution are used for each kilogram of casing weighed as dry casing, i.e., before washing with water.

After treatment, the acid solution is usually removed and the casings are left to drain slightly.

### Alkaline Treatment

The casing obtained in the preceding step is then subjected to treatment with the aqueous alkaline solution according to step b) of the method.

Said alkaline solution has a pH preferably comprised between 8.5 and 10.5 and more preferably comprised between 9 and 10.

To prepare said alkaline solution, a food grade alkaline agent such as for example, hydroxides, carbonates, bicarbonates, phosphates, or acetates of alkaline or alkaline earth metals, or the mixtures thereof is dissolved in water.

In a preferred embodiment of the present invention, the alkaline solution of step b) is an aqueous solution of a food grade alkaline agent selected from the group consisting of hydroxides, carbonates, bicarbonates, phosphates, or acetates of alkaline or alkaline earth metals, or the mixtures thereof; the alkaline agent is preferably sodium bicarbonate.

Said alkaline treatment is performed for a period preferably comprised between 3 and 16 hours and more preferably comprised between 6 and 8 hours.

The treatment with the alkaline solution is usually performed at room temperature.

The method is similar to that followed for acid treatment, such that the casing is submerged in the aqueous alkaline solution seeking to ensure that it is well impregnated in the solution.

Between 2.5 liters and 4 liters of basic solution are usually used for each kilogram of casing and more preferably approximately 3 liters of basic solution are used for each kilogram of casing weighed as dry casing, i.e., before washing with water and acid treatment.

The casing is then removed from the alkaline solution and dried.

### Drying

Once treated according to steps a) and b) of the method of the invention, the casing is dried on a flexible and inflatable support. The support is preferably a cylindrical tube made of an inflatable plastic material such that it can be inflated with air or any other gas such as nitrogen, argon, or helium, for example, until reaching the desired caliber.

In the method of the invention the casing is generally arranged on the tube made of a flexible and inflatable material, being moved thereon such that it is well extended on same.

The tube is then inflated whereby it expands to its final caliber and the casing is left to dry.

The drying of step c) is preferably performed at a temperature not greater than 35° C. and more preferably not greater than 30° C.

The drying of step c) is preferably performed under a relative humidity of less than 30%.

The drying of step c) is performed for a time period preferably comprised between 30 and 150 minutes and more preferably between 50 and 70 minutes.

After this time and once the casing is dry, the flexible support is deflated and the casing is removed from same. As a result of using a flexible and inflatable support, the process of removing the casing from the support is performed in a more comfortable and safe manner and damages to the casing during removal are thus prevented.

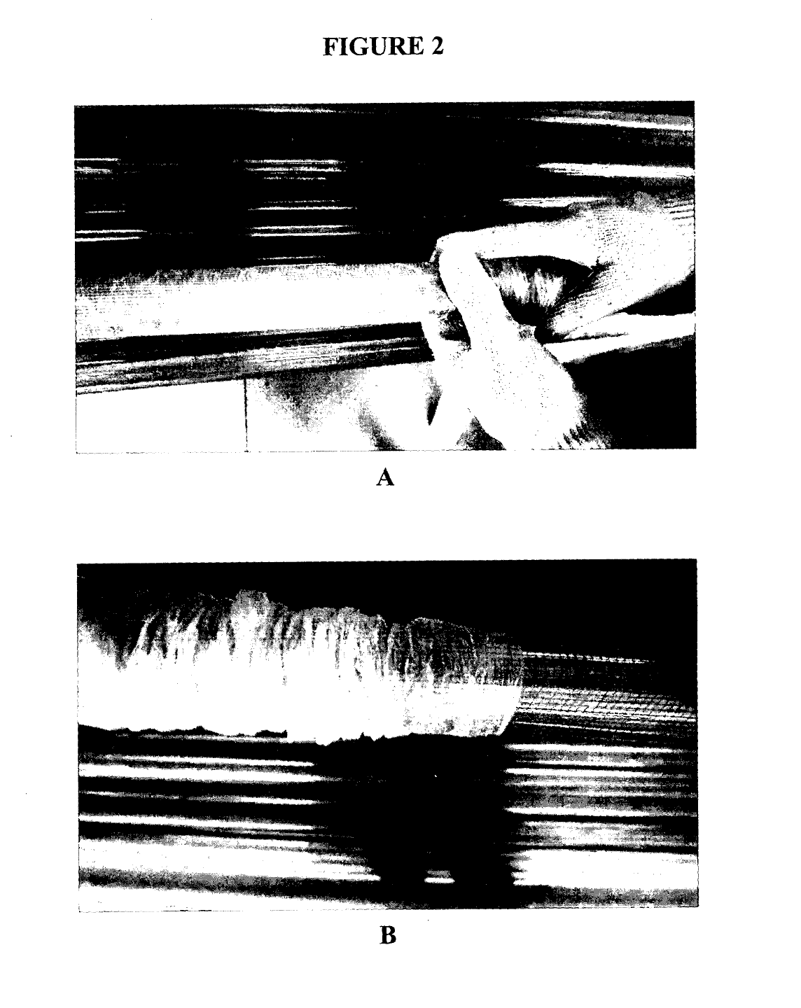

The photographs of FIG. 2 show the introduction of the casing into the support for drying (A) and the subsequent removal of the casing from the support once dried (B).

Optionally, before drying on the cylindrical support made of a flexible and inflatable material according to step c) of the method of the invention, the casing can be arranged in a cylindrical support made of a rigid material, preferably a stainless steel tube, preferably for a time not greater than 15 minutes. During this period the casing is kept at a temperature preferably comprised between 18° C. and 30° C. and more preferably comprised between 20° C. and 25° C. and under a relative humidity comprised between 20% and 40%, preferably between 25% and 35%, and yet more preferably between 29% and 31%.

Preferably the cylindrical support made of a rigid material has substantially the same caliber as the support made of a flexible and inflatable material on which drying will subsequently be performed.

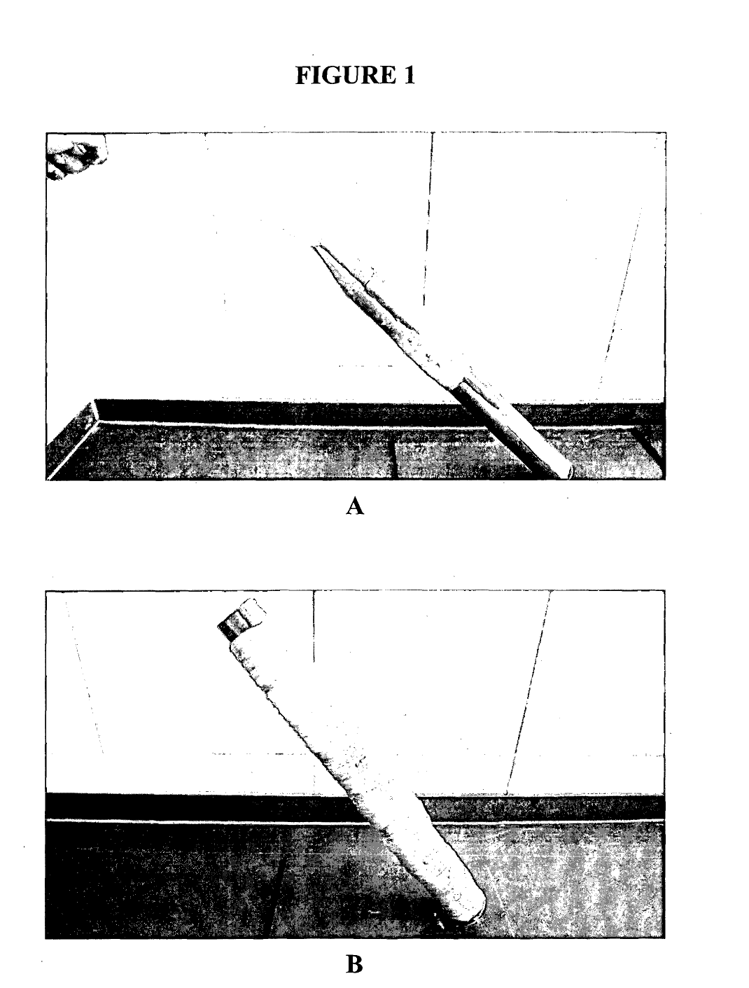

FIG. 1 shows how the casings once subjected to the dual acid and base treatment are introduced into a stainless steel tube before the drying of step c).

The authors of the present invention have found that the developed method, including the combination of the acid treatment of the natural casing followed by a base treatment along with drying thereof in mild conditions in a flexible support, surprisingly allows obtaining a casing with a substantially uniform caliber and at the same time with an appearance similar to that of an artificial casing since it is clear and has no vein or “stubble” marks which are present in the original intestine. Furthermore, the use of a flexible support prevents the casing from suffering damage during the process of removing same.

The method developed allows overcoming one of the main problems of the natural casing: the irregularity and caliber variability thereof. According to this method, a casing with a specific final caliber different from the original can be obtained depending on the size of the support on which the drying is performed, such that the casing fixes the caliber according to the caliber of the support.

The method of the present invention allows obtaining a modified casing with a higher or lower caliber than that of the original casing, casings with a diameter up to 8 mm larger than the original or up to 10 mm smaller than the original being able to be obtained.

Natural casing with a caliber comprised between 16 mm and 55 mm and preferably comprised between 18 mm and 45 is usually used, whereby modified casings with a caliber comprised between 6 mm and 63 mm and more preferably comprised between 8 mm and 53 mm can be obtained.

To that end inflatable cylindrical supports made of a flexible material the final caliber of which is comprised between 6 mm and 63 mm once inflated and preferably comprised between 8 mm and 53 mm are used.

In the method of the invention, the caliber of the flexible support once inflated determines the caliber of the resulting casing.

The flexible and inflatable support used is usually made of a flexible plastic material such as polyethylene, polypropylene, natural rubber, synthetic rubber, silicone, or PVC, for example. The length of said support can vary although it is usually comprised between 15 m and 35 m.

In a preferred embodiment of the invention, once the casing is dried in the conditions specified in step c) and removed from the support, it is subjected to an additional drying at a higher temperature comprised between 80° C. and 100° C. and preferably comprised between 90° C. and 95° C. This second drying is performed under a relative humidity preferably comprised between 5% and 20% and the humidity is more preferably approximately 10%. This second drying is performed for a time period preferably comprised between 15 and 60 minutes and more preferably between 25 and 35 minutes.

In a yet more preferred embodiment, once the second drying ends the casing is subjected to an additional drying in mild temperature conditions comprised between 20° C. and 30° C., more preferably comprised between 22° C. and 28° C., and yet more preferably at a temperature of approximately 25° C. The relative humidity in this additional drying is preferably not greater than 30% and the drying time is at least 24 hours.

A particularly preferred embodiment of the method of the invention comprises the following steps:

a) treating a natural casing with an aqueous acid solution;

b) treating the casing obtained in step a) with an aqueous alkaline solution;

c) drying the casing obtained in step b) on a cylindrical support made of a flexible and inflatable material at a temperature not greater than 35° C.;

d) drying the casing obtained in step c) at a temperature comprised between 80° C. and 100° C.;

e) drying the casing obtained in step d) at a temperature comprised between 20° C. and 30° C.

The preferred conditions for each of steps a), b), c), d) and e) are those specified above.

In an especially preferred embodiment, the method of the invention consists essentially of steps a) to e).

In a preferred embodiment of the invention, after the drying step c), once the casing is demolded, the external part thereof is greased with a mixture of oil and glycerin by means of spraying or brushing.

In another preferred embodiment of the invention, after the third additional step of drying at a temperature comprised between 20° C. and 30° C., step e), the external part of the casing is greased with a mixture of oil and glycerin by means of spraying or brushing.

In a particularly preferred embodiment of the invention, the treatment with the mixture of oil and glycerin is performed twice such that after step c) and also after step e), the outer part of the casing is greased with the mixture of oil and glycerin by means of spraying or brushing.

The term “brushing” is understood as the application of the mixture of oil and glycerol with a brush or with a similar utensil, thus distributing the mixture on the surface of the casing.

The oil used for this coating can be any plant or animal oil suitable for food, it is preferably a plant oil such as for example, sunflower seed oil, olive oil, corn oil, soybean oil, peanut oil, or the mixtures thereof.

The mixture of oil and glycerol is prepared at an oil:glycerol ratio expressed in volume preferably comprised between 90-40:10-60, more preferably between 80-60:20-40, and yet more preferably between 75-65:25-35.

A particularly preferred embodiment of the method of the invention comprises the following steps:

a) treating a natural casing with an aqueous acid solution of pH comprised between 4.5-6.5;

b) treating the casing obtained in step a) with an aqueous alkaline solution of pH comprised between 8.5-10.5;

c) drying the casing obtained in step b) on a cylindrical support made of a flexible and inflatable material at a temperature not greater than 35° C. for a time period comprised between 30 and 150 minutes;

d) greasing the outside of the casing obtained in step c) with a mixture of oil and glycerin;

e) drying the casing obtained in step d) at a temperature comprised between 80° C. and 100° C. for a time period comprised between 15 and 60 minutes;

f) drying the casing obtained in step e) at a temperature comprised between 20° C. and 30° C. for a time period of at least 24 hours;

g) greasing the outside of the casing obtained in step f) with a mixture of oil and glycerin.

The preferred conditions for each of steps a) to g) are those specified above.

In another especially preferred embodiment, the method of the invention consists essentially of steps a) to g).

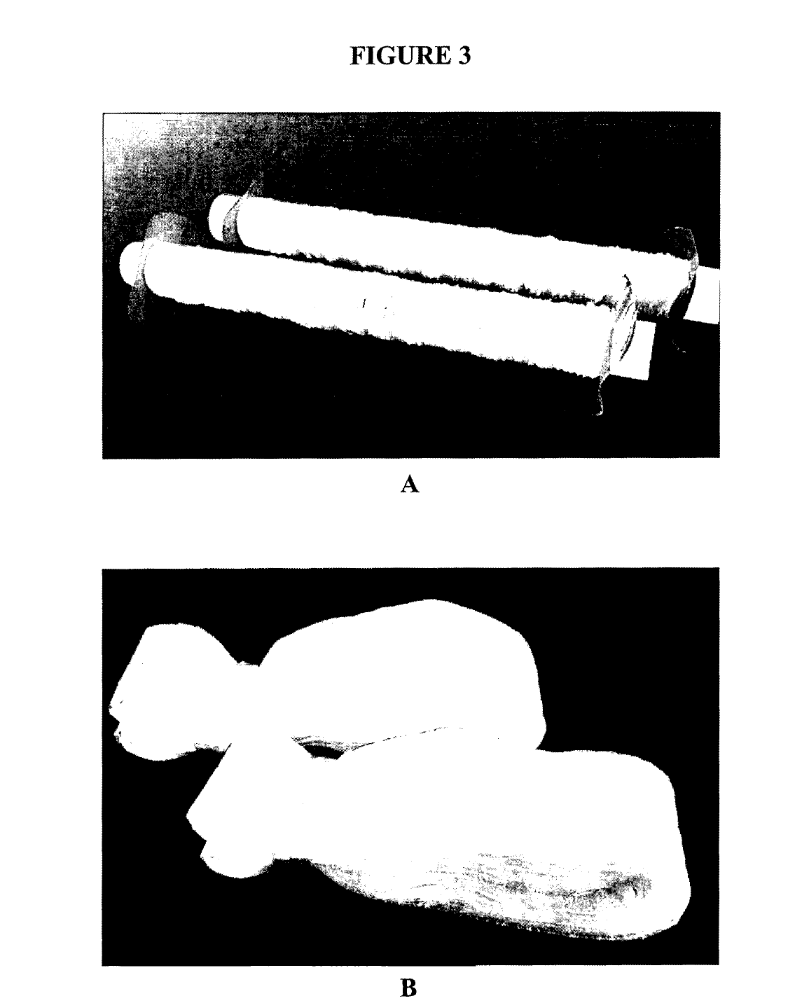

Once the process ends, the natural casing obtained can, for example, be shirred on tubes or folded for subsequent distribution. FIG. 3 shows 2 photographs of the finished casing which is ready for distribution.

Natural Casing with a Substantially Uniform Caliber

The authors of the present invention have observed that the casing obtained after the process maintains the typical characteristics of the natural casing in terms of its elasticity, strength, permeability and cling. However, the structure thereof is modified as a result of the treatment, which allows obtaining a natural casing with improved properties mainly a homogenous caliber and shape and a better clarity and the absence of marks.

Therefore, the method of the present invention allows obtaining a modified natural casing that conserves all the advantages of the natural casing which at the same time also incorporates the main advantages of the artificial casing in terms of its homogenous caliber and shape and clear appearance which is free from marks and irregularities.

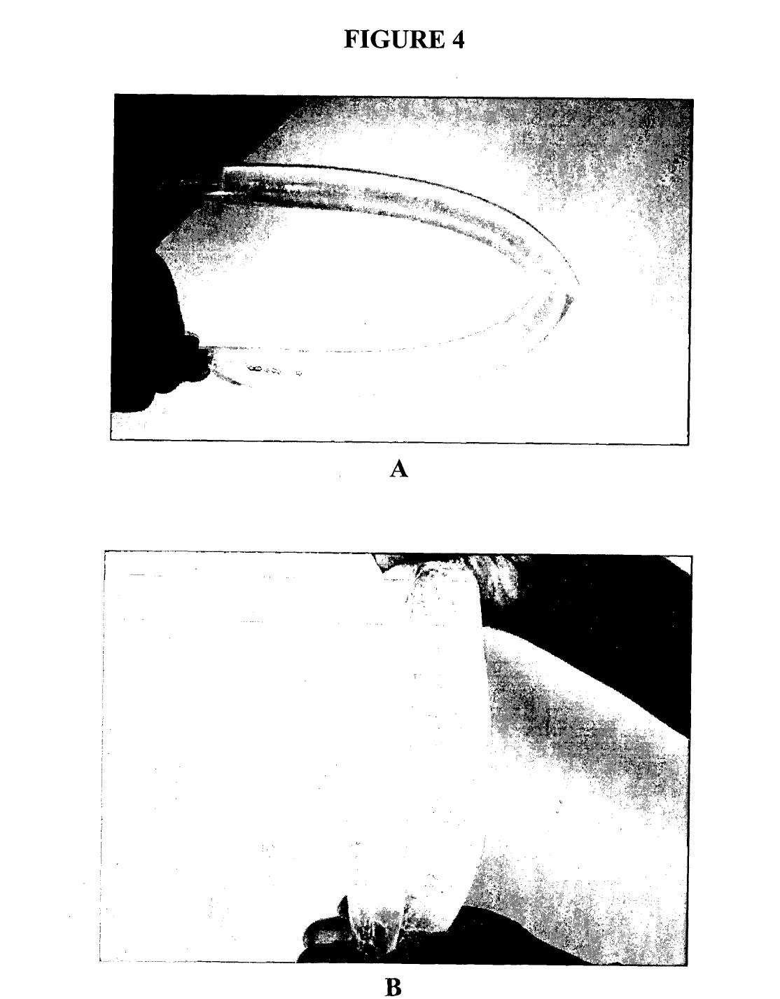

FIG. 4-A shows a photograph of a casing obtained according to the process of the present invention where the mentioned properties can be seen. In contrast, the photograph of FIG. 4-B shows a natural casing which has not been treated in which the marks and irregularities thereof are evident.

Therefore, another aspect of the invention is the natural casing obtainable according to the method of the invention.

An additional advantage of the present invention is that it allows preparing a natural casing of any desired length easily by means of joining several pieces of modified natural casing with an identical caliber prepared according to the method of the invention. Two or more pieces of modified natural casing can, for example, be joined by overlapping the ends of different casings during drying.

Due to their already mentioned improved properties, the modified natural casing is especially useful as skin for preparing filled meat products.

Therefore, another aspect of the present invention is the use of the natural casing of the invention for preparing filled products.

Said filled products are prepared according to the methods known in the scope of the food industry. Said methods usually comprise initially filling the casing with normally raw ground meat of various origin (pork, beef, chicken, etc.) even though a certain type of filled product can be prepared with an already pre-cooked filler.

The products thus obtained may be intended for direct raw consumption or may be subjected to various additional processes: they may be cooked, cured, smoked, salted, etc., according to methods known by the person skilled in food technology.

Another aspect of the invention is a filled product comprising the natural casing of the invention as skin.

An example of the method of the invention is described below for illustrative purposes but it should not be considered as limiting same.

### EXAMPLE

### Example 1

### Preparing a Natural Casing with a Uniform Caliber of 30 mm

Natural casing with calibers comprised between 28 and 40 mm and preserved in salt was used to prepare a casing with this caliber.

50 Kg of said casing were weighed and cleaned with plenty of water to remove the salt.

150 liters of an acetic acid solution in water at pH 6 were prepared in a container. The previously washed and desalted casing was introduced into said solution, stirring it gently so that it was well impregnated in the acid solution. After 10 hours the acid solution was removed and the casings were left to drain for a few minutes.

150 liters of an aqueous sodium bicarbonate solution at pH 10 were then prepared. The casings were introduced into said solution and kept for 7 hours at room temperature. After this time, the casings were taken out from the alkaline solution while arranging them in stainless steel tubes with 30 mm caliber at the same time. The temperature of the room was 20° C. and the relative humidity was 30%. Next, after approximately 10 minutes, each casing was placed on a flexible and inflatable plastic tube with 30 mm caliber and an approximate length of 16 m. The casings were extended along the tube and the tube was then inflated with air until reaching the final caliber of 30 mm.

The casings arranged on the tubes were left to dry for 60 minutes in a room where the temperature was set at 30° C. and the relative humidity at 25%.

The tubes were then deflated and the casing removed. The latter was sprayed with a mixture of plant oil and glycerin and the casing was immediately passed to an oven where it was kept at a temperature of 90° C. and at a relative humidity of 10% for 30 minutes.

After this time, the casings were passed to a room at a temperature of 25° C. and a relative humidity of 25%. After 48 hours, the casings were sprayed again with the same mixture of oil and glycerin and were shirred on a tube for marketing.

1. A method for preparing a natural casing with a substantially uniform caliber, comprising the following steps:
a) treating a natural casing with an aqueous acid solution;
b) treating the casing obtained in step a) with an aqueous alkaline solution; and
c) drying the casing obtained in step b) on a cylindrical support made of a flexible and inflatable material.

2. The method according to claim 1, wherein the aqueous acid solution of step a) has a pH comprised between 4.5 and 6.5.

3. The method according to claim 2, wherein the aqueous acid solution of step a) is an aqueous solution of an acid selected from the group consisting of acetic acid, ascorbic acid, citric acid, hydrochloric acid, glutaric acid, propanoic acid, tartaric acid, and the mixtures thereof.

4. The method according to claim 1, wherein the aqueous alkaline solution of step b) has a pH comprised between 8.5 and 10.5.

5. The method according to claim 4, wherein the aqueous alkaline solution of step b) is an aqueous solution of an alkaline agent selected from the group consisting of hydroxides, carbonates, bicarbonates, phosphates, or acetates of alkaline or alkaline earth metals, or the mixtures thereof.

6. The method according to claim 1, further comprising the following step:
d) drying the casing obtained in step c) at a temperature comprised between 80° C. and 100° C.;

7. The method according to claim 6, further comprising the following step:
e) drying the casing obtained in step d) at a temperature comprised between 20° C. and 30° C.

8. The method according to claim 1, wherein said step c) is performed at a temperature not greater than 35° C., and the method further comprises the following steps:
d) drying the casing obtained in step c) at a temperature comprised between 80° C. and 100° C.; and
e) drying the casing obtained in step d) at a temperature comprised between 20° C. and 30° C.

9. The method according to claim 1, wherein after step c), the external part of the casing is greased with a mixture of oil and glycerin by means of spraying or brushing.

10. The method according to claim 8, wherein after step c), the external part of the casing is greased with a mixture of oil and glycerin by means of spraying or brushing.

11. The method according to claim 7, wherein after step e) the outer part of the casing is greased with a mixture of oil and glycerin by means of spraying or brushing.

12. The method according to claim 8, wherein after step e) the outer part of the casing is greased with a mixture of oil and glycerin by means of spraying or brushing.

13. The method according to claim 10, wherein after step e) the outer part of the casing is greased with a mixture of oil and glycerin by means of spraying or brushing.

14. The method according to claim 1, wherein:
said aqueous acid solution of said step a) has a pH comprised between 4.5-6.5;
said aqueous alkaline solution of said step b) has a pH comprised between 8.5-10.5;
said step c) is performed at a temperature not greater than 35° C. for a time period comprised between 30 and 150 minutes;
wherein the method further comprises the following steps:
d) greasing the outside of the casing obtained in step c) with a mixture of oil and glycerin;
e) drying the casing obtained in step d) at a temperature comprised between 80° C. and 100° C. for a time period comprised between 15 and 60 minutes;
f) drying the casing obtained in step e) at a temperature comprised between 20° C. and 30° C. for a time period of at least 24 hours; and
g) greasing the outside of the casing obtained in step f) with a mixture of oil and glycerin.

15. The method according to claim 1, wherein prior to step c) the casing is arranged in a cylindrical support made of a rigid material for a time not greater than 15 minutes at a temperature comprised between 18° C. and 30° C. and under a relative humidity comprised between 20% and 40%.

16. A natural casing obtainable by a method for preparing a natural casing with a substantially uniform caliber, comprising the following steps:
a) treating a natural casing with an aqueous acid solution;
b) treating the casing obtained in step a) with an aqueous alkaline solution; and
c) drying the casing obtained in step b) on a cylindrical support made of a flexible and inflatable material.

17. A method for using a natural casing for preparing filled products, wherein the natural casing is obtained by a method for preparing a natural casing with a substantially uniform caliber, comprising the following steps:
a) treating a natural casing with an aqueous acid solution;
b) treating the casing obtained in step a) with an aqueous alkaline solution; and
c) drying the casing obtained in step b) on a cylindrical support made of a flexible and inflatable material.

18. A filled product comprising a natural casing as skin, wherein the natural casing is obtained by a method for preparing a natural casing with a substantially uniform caliber, comprising the following steps:
a) treating a natural casing with an aqueous acid solution;
b) treating the casing obtained in step a) with an aqueous alkaline solution; and
c) drying the casing obtained in step b) on a cylindrical support made of a flexible and inflatable material.
